(19) United States
(12) Patent Application Publication
(10) Pub. No.: US 2024/0083732 A1
(43) Pub. Date: Mar. 14, 2024

(54) SYSTEM AND METHOD FOR PRESSURE COOKING/SEALING GLASS JARS

(71) Applicant: Anja Skodda, Venice, CA (US)

(72) Inventor: Anja Skodda, Venice, CA (US)

(21) Appl. No.: 18/243,663

(22) Filed: Sep. 8, 2023

Related U.S. Application Data
(60) Provisional application No. 63/404,546, filed on Sep. 8, 2022.

(51) Int. Cl. B67C 3/26; A23K 20/147; A23K 20/158; A23K 20/163; A23K 30/00; A23K 40/00; A23K 50/48; B67B 3/00

(52) U.S. Cl. CPC B67C 3/26; A23K 20/147; A23K 20/158; A23K 20/163; A23K 30/00; A23K 40/00; A23K 50/48; B67B 3/00

(57) ABSTRACT

A system and method for filling, processing, and sealing glass jars containing food including food for animals. The system includes a filler mechanism having inlet and outlet ports. The filler mechanism drives malleable food from the inlet port to the outlet port. The food exits the outlet port into a mouth opening of a glass jar and enters the jar. The system includes a cover for the glass jar where the cover is sealed to the mouth opening. The method includes providing the glass jar and malleable food. A filler mechanism having inlet and outlet ports is also provided. The food is inserted through the inlet port into the filler mechanism and travels to the outlet port. The filler mechanism pushes the food through the outlet port such that the food passes through a mouth opening of and into the jar. The glass jar is sealed with a cover.

The present invention claims priority under 35 USC 119(e) to U.S. Provisional Application No. 63/404,546, filed Sep. 8, 2022, the entire contents of which is incorporated by reference.

### FIELD OF THE INVENTION

The field of the invention and its embodiments relate to a system and method for pressure cooking and sealing glass jars. In particular, the present invention and its embodiments relate to a system and method for filling, processing, and sealing glass jars containing food. The system and method can be used for human food. Alternatively, the system and method are particularly effective when the food is for animals, including canines.

### BACKGROUND OF THE INVENTION

Food stored in sealed glass jars may lose its freshness and nutritional value if stored for significant periods of time before being consumed. This loss of freshness and nutritional value may occur when the food is for humans and/or animals, including canines.

### SUMMARY OF THE INVENTION

The present invention and its embodiments relate to a system and method for filling, processing, and sealing glass jars containing food. The system and method may be used for food that is to be fed to humans. Alternatively, the system and method are particularly effective when the food is for animals. The system and method is used to produce a shelf stable product without preservatives having no need for refrigeration of the food.

The system includes a filler mechanism having a driver mechanism, and inlet and outlet ports. The filler mechanism also has a filler bowl such that the food can be inserted through the inlet port into the filler bowl. The driver mechanism includes a portion filler or a piston for driving the food from the filler bowl through the outlet port and subsequently a mouth opening of a glass jar such that the food driven through the mouth opening enters an interior region of the jar. The system includes a cover for the glass jar where the cover is sealed to the mouth opening such that the food is contained entirely by the jar and cover.

The method includes providing a glass jar and a quantity of malleable food. A filler mechanism having a driver mechanism is also provided. The filler mechanism has inlet and outlet ports, and a filler bowl. The malleable food is inserted through the inlet port into the filler bowl. The filler mechanism is operated such that the driver mechanism pushes the food from the filler bowl through the outlet port such that the food passes through a mouth opening of and into the jar. The glass jar is sealed with a cover so the food is contained entirely by the jar and cover.

### BRIEF DESCRIPTION OF THE DRAWINGS

FIG. 1 depicts a schematic diagram of part of the disclosed system for pressure cooking/sealing glass jars, the components for processing the food following filling of the jars being omitted according to at least some embodiments described herein.

FIG. 2 depicts a schematic diagram of part of the filler mechanism and jar of the system of FIG. 1, the depicted filler mechanism providing for intermittent filling of the jar according to at least some embodiments described herein.

FIG. 3 depicts a schematic diagram of an alternative embodiment of part of the filler mechanism and jar of the system of FIG. 2, the depicted filler mechanism providing for intermittent filling of the jar according to at least some embodiments described herein.

FIG. 4 depicts a schematic diagram of a method for processing the jar of FIGS. 1 to 3 following filling of the jar with food, according to at least some embodiments described herein.

FIG. 5 depicts a heating factor graph for Filename 22080401.

FIG. 6 depicts the sensor locations.

### DETAILED DESCRIPTION OF THE INVENTION

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements.

This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the term “about” is used in conjunction with a numerical range, it modifies that range by extending the boundaries above and below those numerical values. In general, the term “about” is used herein to modify a numerical value above and below the stated value by a variance of 20%, 10%, 5%, or 1%. In certain embodiments, the term “about” is used to modify a numerical value above and below the stated value by a variance of 10%. In certain embodiments, the term “about” is used to modify a numerical value above and below the stated value by a variance of 5%. In certain embodiments, the term “about” is used to modify a numerical value above and below the stated value by a variance of 1%.

When a range of values is listed herein, it is intended to encompass each value and sub-range within that range. For example, “1-5 ng” is intended to encompass 1 ng, 2 ng, 3 ng, 4 ng, 5 ng, 1-2 ng, 1-3 ng, 1-4 ng, 1-5 ng, 2-3 ng, 2-4 ng, 2-5 ng, 3-4 ng, 3-5 ng, and 4-5 ng.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

The system and method for pressure cooking/sealing glass jars 10, 12 is used to produce a shelf stable product without preservatives having no need for refrigeration of the product. Such food 11 is typically used to feed domesticated animals, such as pets including canines. The food 11 is a wet stew like product.

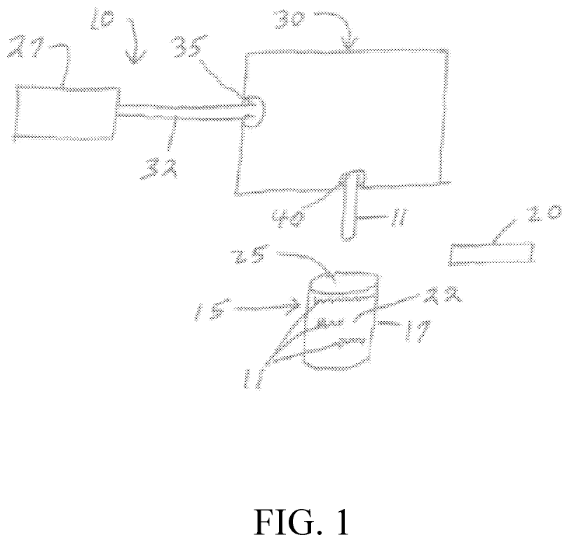

The system 10 for pressure cooking/sealing glass jars 10 includes a container 15 having a glass jar 17 and cover 20, as shown in FIG. 1. The glass jar 17 has an interior region 22 and mouth opening 25 such that the interior region may be accessed through the mouth opening. Embodiments of the cover 20 include a cap or lug lid.

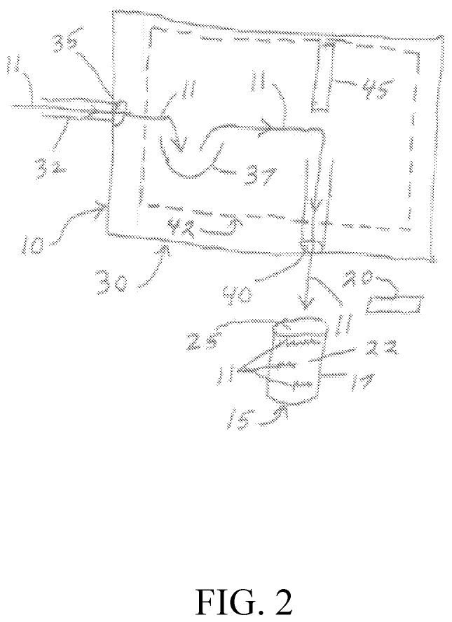

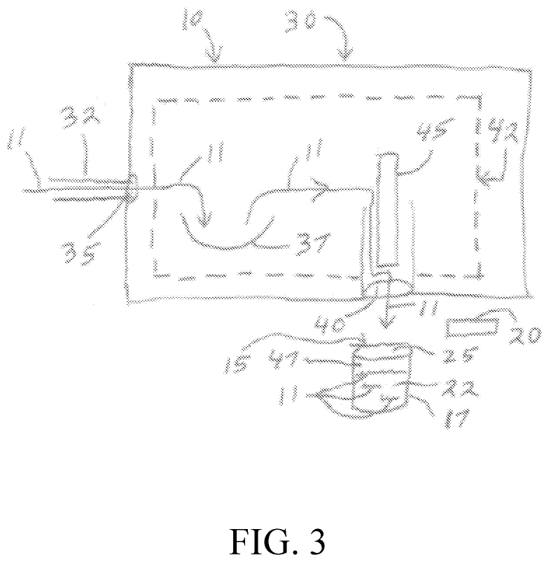

The system 10 has a reservoir 27 in which the food 11 resides before filling of the glass jars 17 with the food by a filler mechanism 30. The system 10 has a transport mechanism 32 for conveying the food 11 in the reservoir 27 to the filler mechanism 30, as shown in FIG. 1. The filler mechanism 30 has an inlet port 35 and a filler bowl 37 (seen in FIGS. 2 and 3) such that the food 11 conveyed to the filler mechanism enters the inlet port 35 and flows to the filler bowl, as shown in FIGS. 2 and 3. The filler mechanism 30 includes an outlet port 40 through which the food 11 exits the filler mechanism. The food 11 is driven from the filler bowl 37 to and through the outlet port 40 by a driver mechanism 42. The driver mechanism 42 may include a piston/portion filler 45. The piston/portion filler 45 may possibly be included in a Point 5 single head portion filler device of the driver mechanism 42. The Point 5 single head portion filler device may be able to uniformly pump the food 11 through the outlet port 40.

The operation of the driver mechanism 42 may provide an intermittent feed of the food 11 to the piston/portion filler 45 such that the food is supplied to the piston/portion filler when it is retracted but the supply of food to the piston/portion filler is halted when the piston/portion filler is driving the food to the outlet port 40, as shown in FIG. 2. Alternatively, the operation of the driver mechanism 42 may provide a continuous feed of the food 11 to the piston/portion filler 45, as shown in FIG. 3.

The glass jar 17 is oriented relative to the filler mechanism 30 such that the mouth opening 25 of the glass jar generally faces the outlet port 40, as shown in FIGS. 1 to 3. This provides for the food 11 exiting the outlet port 40 to flow through the mouth opening 25 and enter the interior region 22.

The filler mechanism 30 may be controlled to drive a quantity of the food 11 into the interior region 22 sufficient to completely fill the glass jar 17, as shown in FIG. 2. Alternatively, the glass jar 17 may be nearly, but not completely, filled to provide a headspace 47 within the interior region 22, as shown in FIG. 3.

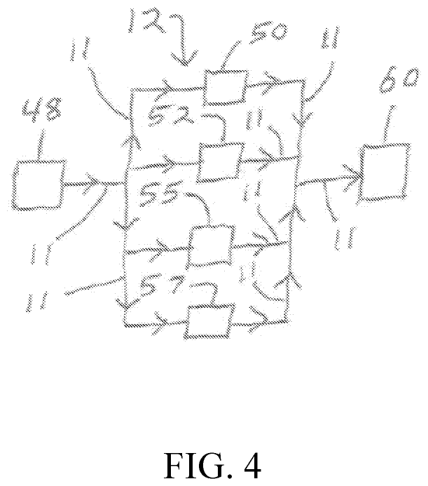

The method 12 includes using the filler mechanism 30 to in the filling process 48, which involves filling the glass jar 17 with food 11. In the filling process 48, which comprises filling the glass jar 17 with the food 11 may be processed according to various methods 12, as shown in FIG. 4. For example, a vacuum 50 may be applied to the interior region 22 such that the food 11 therein is subjected to a vacuum. Creating a vacuum 50 without adding steam is a possible embodiment. The method 12 may also provide for heating 52 of the glass jar 17.

Another possible method 12 includes hand capping rather than steam capping in the presence of overpressure retorting 55 so as to avoid or to generate a vacuum 50 in the interior region 22. An additional possible method 12 involves processing the glass jar 17 using an Allpax Versatort Retort 55 and heating 52 the jar by immersion thereof in water.

The immersion may be horizontal. A further possible method 12 provides for a better understanding of both the values for incoming ingredients and the finished product following sterilization 57 which may help understand both this and thermal nutrient destruction.

The method 12 includes securing 60 the cover 20 to the edge of the glass jar 17 which defines the outer boundary of the mouth opening 25. This happens after the methods 12 of processing of the glass jar 17 with the food 11 shown in FIG. 4. The cover 20 is typically secured 60 to the entire edge of the glass jar 17 to form an airtight seal so no fluid, solid, or gas may enter or exit the interior region 22. When the cover 20 is sealed 60 to the glass jar 17, the food 11 is located in the interior region 22.

The food 11 sealed in the glass jar 17 may have the following compositions. The suffixes “-1”, “-2”, and “-3” are used in the following to indicate the different compositions of the food.

### Embodiment 1

at least 15% of the food 11-1 is crude protein,
at least 3% of the food 11-1 is crude fat,
a maximum of 1% of the food 11-1 is crude fiber, and
a maximum of 70% of the food 11-1 is moisture.

### Embodiment 2

at least 15% of the food 11-2 is crude protein,
at least 4% of the food 11-2 is crude fat,
a maximum of 1% of the food 11-2 is crude fiber, and
a maximum of 75% of the food 11-2 is moisture.

### Embodiment 3

at least 15% of the food 11-3 is crude protein,
at least 7% of the food 11-3 is crude fat,
a maximum of 1% of the food 11-3 is crude fiber, and
a maximum of 70% of the food 11-3 is moisture.

Sample method for filling jars with food and processing food A possible embodiment for a sampling method 12 for filling glass jars 17 with the food 11 and a method 12 for processing the food 11 follows.
(i) The frozen ingredients of the food 11 are thawed overnight prior to production under refrigeration.
(ii) The 301b. batches of food 11 are blended in a cold room, if possible, to minimize deterioration.
(iii) Each batch of food 11 is transferred to the filler bowl 37 of the Point Five single head piston/portion filler 45. Attempts may be made to transfer the batch of food 11 through a valve and into the glass jar 17.
(iv) The food product 11 will be cold filled.
(v) The target fill weight of the food 11 may be 400 g. The required headspace 47 of approximately 1″ should be determined based on a process authority recommendation. If the food product 11 density is such that the 400 g fill weight of the food is not possible, then the fill weight is adjusted and recorded.
(vi) If filling of the food 11 to a constant desired weight is not provided by the filler mechanism 30, the glass jars 17 will be hand filled with the food 11 and the method 12 will continue.
(vii) Each glass jar 17 will be capped using hand tightening.
(viii) The 26 glass jars 17 (minimum) will then be loaded into the Allpax Versatort Retort 55.
   a. The glass jars 17 are placed in the center of the retort 55 with the remainder of the cavity loaded with blanks. Tray inserts are put in place as a barrier to separate the glass jars 17.
   b. Separate retort cycles 55 are used for each formula.
   c. 6 glass jars 17 have probes (thermocouples) inserted into the covers 20 for recording retort 55 condition information and verifying commercial sterility.
(ix) Thermal process (time/temperature/pressure) of the cooking and cooling cycle as well as the value of glass jar 17 agitation during retort 55 are at the discretion of the process authority. The target will be a minimum of 7 to create a margin of safety.
(x) The food product 11 will be held a minimum of 7 days post process as added evidence of achievement of thermal sterility and to allow texture stabilization. The food product 11 and production date are identified on each glass jar 17.

### Lagarde Sterilizer: Processing Food Product

The food product 11 may be processed in a Lagarde static steam water spray batch sterilizer. Following are the conditions under which such a process may be performed.
Food Product 11: Pet Food 11
Formula (code): Chicken Casserole, Beef & Broccoli, and Pork & Sweet Potato
Container: 300×406, or 300×410 glass jar 17
Maximum Fill Weight: 480.0 grams
Minimum Sterilizer Temperature (° C.): 121.1° C.
Minimum Initial Temperature: 5° C.
Minimum process time: 84.1 minutes
Minimum Come Up Time: 30.4 minutes
Least Fo: 11 minutes

The formulations are a critical factor. Any formula changes must be reviewed by a processing authority.

The retort temperatures provided immediately above are minimum temperatures. The temperatures and times may be increased if required to achieve the proper “quality” for the beans.

Process time has been credited with 42% of the come-up time (CUT). Numerical confirms the CUT credit and is listed in the immediately following BCC section.

BCC: The following are ingredients that may be present in the formulations of the present invention: chicken parts such as breasts, thighs, wings, legs, gizzards, and the like, ground chicken, eggs, beef stew meats, ground beef, pork parts such as tenderloins, shoulder, ribs, pork belly, rump, and the like, ground pork, broths of chicken, beef, and/or pork, grains such as rice, barley, millet, spelt, buckwheat, farro, teff, corn, bulgur, oats, brown rice, sorghum, wheat, rye, amaranth, kamut, freekeh, bran, triticale, einkorn, lentils, and the like, vegetables/plants such as sweet potatoes, potatoes, broccoli, spinach, kale, beets, carrots, pumpkin, cucumber, zucchini, asparagus, celery, seaweed, and the like, beans such as kidney beans, pinto beans, chickpeas, lima beans, green beans, black-eyed peas, black beans, cannellini beans, great northern beans, fava beans, navy beans, adzuki beans, edamame, mung beans, soybeans, cranberry beans, and the like, fish parts and/or oils, such as salmon, trout, tilapia, bass, and the like, fruit extracts, such as extracts from citrus fruits, bananas, apples, nectarines, peaches, cranberries, and the like, yeast that may be enriched with elements such as sulfur, selenium, tellurium, phosphorus, nitrogen, calcium, sodium, and the like, other minerals/nutrients, and/or water.

z Value: 10.00 Reference Temp: 121.10 Initial Temp: 5.00
Temp Unit: ° C. Simple/Broken: S

| Seg | Segment | Duration | Accum | Start | Final | Seg | Seg | Cold | Accum F |
|---|---|---|---|---|---|---|---|---|---|
| No | Type | (min) | Time | RT | RT | jh/jc | fh/f2/fc | Spot | (min) |
| 1 | Simple | 30.00 | 30.00 | 121.10 | 121.10 | 2.71 | 51.62 | 43.04 | 0.000 |
| 2 | Simple | 79.33 | 109.33 | 121.10 | 121.10 | 2.71 | 51.62 | 118.65 | 11.078 |
| 3 | Cooling | 10.00 | 119.33 | 90.00 | 90.00 | 1.63 | 52.38 | 116.51 | 16.351 |

Accumulated F(10.00/121.10) contributed by all heating segments(min): 11.078
Accumulated F(10.00/121.10) contributed by all cooling segments(min): 5.272

### Legarde Sterilizer: Heat Penetration Study

Heat penetration tests were conducted in order to develop a static thermal process for pet food 11 packaged in 300×410, and/or 300×406 glass jars 17 in a Lagarde static steam water spray batch pressure sterilizers.

Test Conditions and Results

Heat Penetration Test Conditions
Food Product 11: Pet Food 11
Formula: Pork & Sweet Potato, Beef & Broccoli
Container size: 300×410 glass jars 17
Fill Weight: 14.4 ounces (425 grams)
Initial temperature: 5° C.
Agitation: None
Temperature set point: 121.1° C.

The following Ball Method heating factors resulted from the study.

| Filename | jh | fh | Notes |
|---|---|---|---|
| 22080201 | 1.9 | 49.43 | Beef Formula |
| 22080308 | 1.6 | 53.42 | Beef Formula |
| 22080401 | 1.74 | 53.02 | Beef Formula |
| 220701 | 2.47 | 36.66 | Pork Formula |

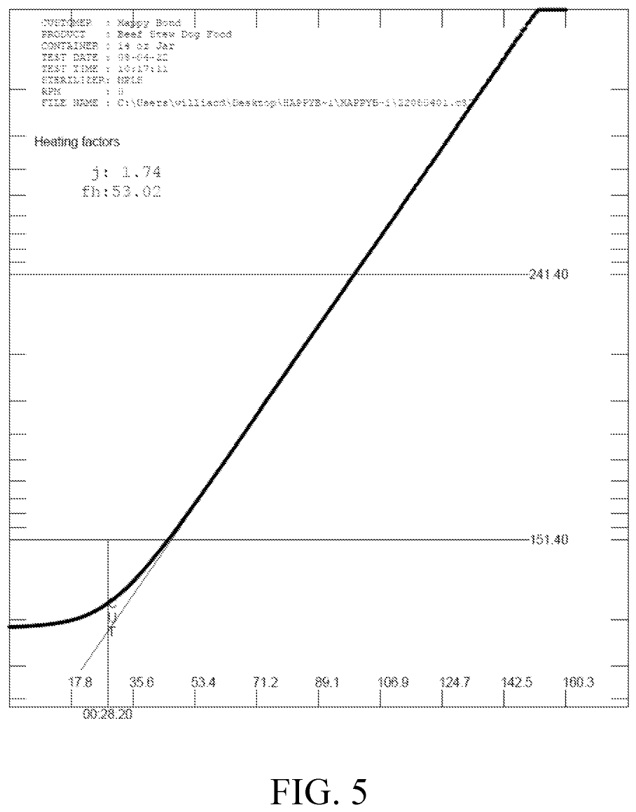

The most conservative heating factors among the tests were for Filename 22080401, above, and shown in FIG. 5.

For all the tests, thermocouples were placed at the geometric center of the food product 11.

### Legarde Retort: Temperature Distribution Study

A temperature distribution study on one 2 basket Lagarde Static Steam Water Spray Retort #1 was performed as follows. The sterilizer was loaded with two (2) baskets of 14.0 oz. water filled or product-filled glass jars 11, 17. The objectives of the study were:
(i) To locate the coldest zone within the sterilizer during the heating segment.
(ii) To verify that the temperature at the coldest zone reaches the minimum sterilization temperature within the specified come-up time (CUT).
(iii) To verify that the temperature readings in the coldest zone are equal to or greater than the minimum sterilization temperature during the sterilization segment.

Three (3) tests were conducted on the Sterilizer. Tests were performed with thermocouples positioned throughout two (2) fully loaded baskets. The tests resulted in the following minimum operating conditions:

| | Container |
|---|---|
| | 14.0 oz. Glass |
| | Jars 17 |
| | Product Sterilization |
| | Temperature |
| | 121.1° C. |
| Minimum IT (° C.) | 7.3 |
| Minimum come-up heating steps | 15 |
| Minimum come-up heating steps time (mins) | 2.0 |
| Retort temperature Setpoint (° C.) | 123 |
| Minimum total come-up time (minutes) | 30.0 |
| Initial Fill Level (mm) | 180 |
| Initial Pressure Setpoint (bar) | 0.02 |
| Sterilization Pressure Setpoint (bar) | 2.3 |
| Cooling Time (minutes) | 50 |

Process Variables in the rows ⋅ above are critical to the thermal process and should not be altered without consultation with a thermal process authority. The minimum come-up time is comprised of 15 temperature ramps, at a minimum of 2 minutes each ramp. The Lagarde controller will execute all of the ramps, but will assure that segment time is equal to, or longer than, to archive segment temperature setpoint is met before advancing to the next segment. Both segment time and temperature will be met before the controller will advance. When the minimum come-up time is met, the machine will advance to the sterilization phase of the cycle. A sterilization segment starts at the beginning of the cook cycle.

Test conditions and results summaries follow.

| | | | | Last Free | | | | |
|---|---|---|---|---|---|---|---|---|
| | IT | RT | All TC | Lead | TID | RTD | Cold Zone | |
| Test Name | (° C.) | (° C.) | >121.1° C. | (#) | (° C.) | (° C.) | Location | Notes |
| 22072702 | 33** | 123.0 | 29.6 | 2 | 123.3 | 123.3 | L2P1 | Water filled |
| 22072703 | 30** | 123.0 | 29.0 | 2 | 124.3 | 123.3 | L2P1 | Water Filled |
| 22072801 | 4-12** | 123.0 | 29.3 | 7 | 123.5 | 123.5 | L1P2 | Product Filled, |
| | | | | | | | | Low IT |

(#) Last sensor: number of the last free lead to reach the minimum scheduled temperature (121.1° C.).
(*) Tests performed with low water flow.
**Internal container temperature was measured.
L#-P#: Layer # (from bottom of basket) - baket # (from back of retort).

### Process Deviation

A possible process deviation follows. The resulting food product 11 met minimum public health and is commercially sterile.

| | Scheduled | Actual | |
|---|---|---|---|
| Come-up Time (min.) | 30.0 | 30.4 | Food Product 11 |
| Process Time (min.) | 84.1 | 90.0 | HappyBond & Broccoli |
| Process Temp. (° C.) | 121.1 | 123.5 | Container Size |
| Initial Temp. (° C.) | 5 | 10 | 14.0 oz glass jar 17 |
| Fill Weight (grams) | 480.0 | 480.0 | Deviation Date |
| | | | Jul. 8, 2022 |
| | | | Code Number/Batch |
| | | | NA |

In an embodiment, the present invention meets the requirements as set out by the FDA and the Department of Health and Human Services of the United States government. In an embodiment, the food products as packaged herein meet the requirements of form FDA 2541d. In an embodiment, the processes of the present invention meet the food processing requirements for low-acid retorted methods. In a variation, the retort methods may include the use of a retort lid that is retorted under pressure. The use of a retort lid allows the cooking to occur under pressure and a vacuum seal of the lid allows the filled ingredients in the jar to remain fresh for up to 2 years or more (without the need for preservatives).

In an embodiment, the product that is packaged by the instantly disclosed processes is dog food, or optionally cat food. In an embodiment, the ingredients that may be added to the food product include green beans, mushrooms (such as button mushrooms), tuna (light), and/or sardines. Other products that may be added include other meat products (including other fish, mammalian farm animal products, and chicken products), other vegetable products (like carrots, spinach, kale, etc.), fruit products, and vitamins and minerals. The food product may be prepared as a loaf style petfood with meat chunks and/or vegetables. The packing medium may include ground/emulsified products mixed with chunk meat and/or vegetables/fruit.

In an embodiment, the containers that are used in the present invention may be jars that are cylindrical (or mainly cylindrical) in shape. Overpressure may be used to help maintain the container integrity. In an embodiment, the overpressure that is used in the present invention may be between about 22 to 25 pounds per square inch, with a possible range of 23 to 25 pounds per square inch, or alternatively about 24.6 pounds per square inch.

In an embodiment, the jar may have container dimensions that are 3 8/16 (or 3½) inches in diameter by 4 inches in height. Alternatively, the dimensions may be between about 3-4 inches in diameter (measured from the outer part of the container) and between about 3-5 inches in height.

In an embodiment, the pH may be appropriately adjusted to attain a desired pH. In an embodiment, the pH may be between about 5-7 in pH or alternatively, about 6 in pH. In a variation, the pH is not important to the process. In an embodiment, the heating medium that may be used to heat the jar may be a water spray.

In an embodiment, the processing mode may be either agitating or still. In a variation, the processing mode should be the still mode.

When filling the container, the fill mode can either be by mass or by volume. In a variation, the fill mode is by volume. In a variation, the fill amount is between 13 and maximally about 17.5 ounces. In an embodiment, the fill amount is 14.32 ounces. In a variation, only one phase is used to fill the container with product. In a variation, the product is vacuum packed. In an embodiment, the product is not vacuum packed. In a variation, the product is packed with overpressure. In a variation, the container is vertical when packing with retort.

In an embodiment, the product contains particulates. In a variation, the product does not contain any dry ingredients.

In an embodiment, the minimum processing temperature is about 8° C. In a variation, the maximal process temperature is about 122° C. In an embodiment, the processing time is about 8 minutes. Testing was performed to ascertain that when retort occurs, whether or not the temperature can be held constant throughout the process at a level that is equal or higher than the minimum process temperature during the cook phase for the container size as disclosed herein. Several glass jar containers with different sizes were considered with sizes of 1) 2 13/16″ in diameter by 7 14/16″ in height, 2) 3 2/16″ in diameter by 5 2/16″ in height and 3) 3 8/16 in diameter and 4″ in height. The process temperature was set at 120° C. and the control temperature at 121° C. and the first (1)) size was tested for temperature distribution.

The container loading pattern was as shown in Table 3

TABLE 3

| | | | Baskets | Containers |
|---|---|---|---|---|
| Containers | Layers | Containers | per | per |
| per | per | per | Retort | Retort |
| Layer | Basket | Basket | Load | Load |
| 164 | 4 | 656 | 2 | 1312 |

In an embodiment, the retort basket is rectangular in shape, constructed out of steel with dimensions that are approximately 32.5″×37.25″×30.75″ (L×W×H). Divider sheets were used that were plastic and had dimensions of 30.75″×35.75″×1″ (L×W×H) with 510 holes (the holes being 1″ in diameter on 2″ centers). The bottom basket plate was stainless steel and had dimensions of 30.75″×35.75″×¼″ (L×W×H) with 1989 holes (the holes being ¾″ diameter on ¾″ centers).

In an embodiment, the temperature distribution equipment used CALSoft Thermal Processing Software. The datalogger was CALPlex 32 channel datalogger. The wires were a continuous temperature distribution cable of type-T copper/constantan thermocouple lead wire with soldered tips. The data collection system was calibrated during the testing by bringing the retort to the setpoint temperature and holding until the entire vessel temperature had equilibrated. The temperature distribution sensors/wires were allowed to stabilize prior to capturing temperature readings. The difference between each reading and the reference temperature on the TID was saved as “calibration factors” (offsets) using the CALSoft software. CALSoft adjusts the temperature reading at each scan during data collection using these calibration offset factors. MIG, RTD, Pressure and other readings were recorded during the tests. Steam head pressure was also recorded prior to opening of the stream valve and monitored for its lowest pressure during the come up phase. Table 4 shows the test summary results with Control Program Setpoints.

TABLE 4

| PHASE | Time | Temperature (° C.) | Pressure (bar) |
|---|---|---|---|
| Initial Bleed (Pre- | 00:10 | 40 | 0.0 |
| heat) | | | |
| Come-Up (Heating) | 21:00 | 122 | 1.7 |
| Come-Up (Heating) | 05:00 | 122 | 1.7 |
| Total Come Up | 26:00 | 122 | 1.7 |
| Time | | | |
| Cook | XX | 121 | 1.7 |
| Control | 00:10 | 121 | 1.7 |
| Pre-cooling | 05:00 | 95 | 1.7 |
| Slow Cooling | 07:00 | 85 | 1.7 |
| Fast Cooling | 45:00 | 35 | 1.0 |
| Drain | 00:10 | 20 | 0.8 |

Table 5 shows additional results from the testing.

TABLE 5

| [symbol] | 1 | |
|---|---|---|
| Test [symbol] | 1 | 2 |
| CALSoft File Name: | [symbol] | [symbol] |
| Date of Text: | Apr. 12, 2023 | Apr. 13, 2023 |
| Container Size: | 213 × 714 - Glass Jar | 213 × 714 - Glass Jar |
| TEST CONDITIONS: | | |
| Loading: | Racking System | Racking System |
| Full or Partial Load: | Full | Full |
| Approx. Initial Temp. of load: | [symbol] ° C. | [symbol] ° C. |
| Additional [symbol] Coming Up: | 0 | 0 |
| Flow Rate (LPH): | 51 | 51 |
| Rotation ( [symbol] PM): | 0 | 0 |
| Line Pressure Before Steam-on: | [symbol] | [symbol] |
| CONTROL TEMPERATURE | | |
| Control Setpoint Temperature: | 121° C. | 121° C. |
| Time TID Reached Setpoint: | 24 [symbol] 00 | 25 [symbol] 00 |
| Time [symbol] Reached Setpoint [symbol] | 24 [symbol] 00 | 25 [symbol] 00 |
| Time Cook cycle start: | 28 [symbol] 12 | 28 [symbol] 35 |
| SLOWEST HEATING [symbol] | | |
| Process Temperature [symbol] | 120° C. | 120° C. |
| Slowest Lead/Probe [symbol] | 19 | 19 |
| Time Reached Setpoint Temp [symbol] | [symbol] | [symbol] |
| Location (#Z,899&#128521; | [symbol] | [symbol] |

[symbol]

indicates data missing or illegible when filed

The temperature distribution testing was performed as described above. Basket 2, Layer 1 was determined to be the slow heating zone under the operating conditions tested. For the come up time, the temperatures tested were equal to or greater than the process temperature. Temperatures during the retort load remained equal to or greater than the process temperature during the duration of the cook phase.

### Retort Operation

The retort starts the process. All valves are closed with the exception of the vent valve. The controller should check the water level in the dammed area below the retort baskets. The water fill valve should then be opened to ensure that the water level is set at the appropriate level. During the come up phase, the process steam control and overpressure air valves are open and set into PID (proportional integration derivative) control loops. The vent control valve and the overpressure air valves work in tandem. If the pressure is too high, the vent control valve opens to relieve excess pressure. The circulation pump is also energized, which pulls water from the bottom of the retort through the circulation pump into the water distribution channel and into the retort. During this period, the temperature and pressure are ramped to preset target levels. The steps in the come up process continue for a minimum time and the process temperature is achieved.

During the cook phase, the retort has met all of the come-up requirements. The process team control, the overpressure, the air and vent valves remain in the PID control loops. Steam as needed continues to enter the steam exchanger. The circulation pump remains energized, moving the process water. The water flow pattern remains the same as in the come-up phase. The cook phase is both time and temperature dependent.

One the thermal process requirements have been met, the control system will automatically place the vessel into the pressure cool phase. This phase contains multiple steps in which the retort is ramped down in temperature and pressure. Pressure cool and atmospheric cool steps are both used.

The next step is the drain step, which is not time dependent. It depends on the sensors and whether the retort is virtually void of water and pressure. The cooling water valve is closed, the circulation pump is turned off, and the drain valve is opened. When both the water level and pressure has dropped to 0 (or close), this phase ends. The operator ca now open the door and unload the baskets. Table 6 shows the conditions and the control program.

TABLE 6
Minimum product I.T. 5° C.
Minimum Steam Supply 60 psig on the steam supply
header prior to the start of the come up phase
Retort Control Temperature: 121° C., for a
process temperature of 120° C.
Flow Rate: 50 GPM during Cook phase
Control Program

| | | | Recipe | Control | |
|---|---|---|---|---|---|
| | | | Set Point | Set Point | Pressure |
| | Segment | Time | (temp ° C.) | (temp ° C.) | (bar) |
| 1 | Fill (Initial | 00:10 | 40 | | 0.00 |
| | Bleed) | | | | |
| 2 | Come-Up | 23:00 | 122 | 123 | 1.70 |
| | (Heating) | | | | |
| 3 | Come-Up | 5:00 | 122 | 123 | 1.70 |
| | (Heating) | | | | |
| 4 | Sterilization | XX | 121 | 122 | 1.70 |
| | (Cooking) | | | | |
| 5 | Pre-cooling | 5:00 | 95 | 96 | 1.70 |
| 6 | Cooling | 7:00 | 85 | 86 | 1.70 |
| 7 | Cooling | 45:00 | 35 | 36 | 1.00 |
| 8 | Drain | 00:10 | 25 | 26 | 0.80 |

All of the parameters must be met before the control program advances to the next segment.

The following example is the thermal process report of a glass jar container that is 3 8/16″ by 4″. The test protocol is heat penetration testing under the “worst case” production conditions. The product tested was a beef and broccoli and a pork and sweet potato. The meat was cut into chunk sizes of 1.2″ by 0.75″×0.55″. The meat chunks were mixed with ground meat, IQF vegetables, hydrated grans, egg yolk powder, sea salt, kelp meal, grand fusion pet blend, and selenium yeast.

Container Fill: The product used in the testing was slightly increased during the preparation of the formulation in order to simulate the “worst case” condition. This change consisted of the increases in the weight of the main ingredients.

Table 7 shows the container fill production and testing parameters.

TABLE 7

| | Container Fill/ | Container Fill/ | Container Fill/ | Container Fill/ |
|---|---|---|---|---|
| | Production | Production | HP Testing | HP Testing |
| Ingredients | Wt (grams) | % | Wt (grams) | % |
| Loaf Style with | 406 | 100 | 465-496 | 100 |
| Chunks | | | | |

Filling/Sealing: Test containers (outfitted with pre-installed thermocouples and receptacles) were hand-filled with chunky petfood mixture. The meat chunk was impaled and the rest of the container was filled to the top of the container. The lid of the container was then hand-tightened to seal.

As before, CALSoft Thermal Processing Software was used. The datalogger was CALPlex 32 channel datalogger. Continuous heat penetration cable of type-T copper/constantan thermocouple lead wire was used. Type-T Needle thermocouples were installed in the container wall. Free leads (Type-T copper constantan wire with soldered tip) was used to monitor the resort temperature outside the test containers.

Retort: Tests were conducted in a commercial size Panini Horizontal Water Spray Retort #1.

Container Loading: The test containers were layer packed in vertical position. Test containers were located in the front basket, closest to the retort door, on the bottom layer.

Thermocouple Position: Based on cold spot testing of this product/can size, the thermocouples were located 1 inch above the bottom of the Glass Jar.

Table 8 shows the results of these tests.

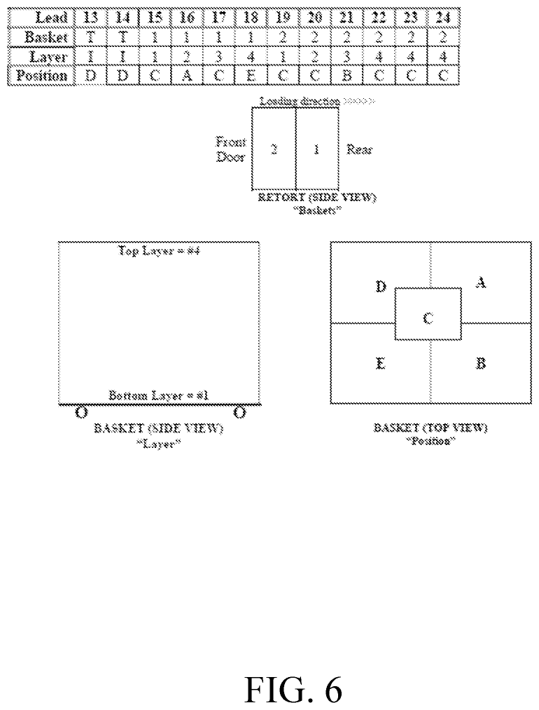

TABLE 8
FIG. 6 shows the sensor (thermocouple) locations.

| Test # | 1 | | 2 | | 3 | | 4 | |
|---|---|---|---|---|---|---|---|---|
| Product | Pork and Sweet | | Beef and | | Beef and | | Beef and | |
| formulation | Potato | | Broccoli | | Broccoli | | Broccoli | |
| Probed | 11 | | 12 | | 12 | | 11 | |
| container | | | | | | | | |
| Thermocouple | 2 1/16″ AB | | 2 1/16″ AB | | 1″ AB | | 1″ AB | |
| position | 1″ AB | | 1″ AB | | | | | |
| | ½″ AB | | ½″ AB | | | | | |
| Initial | 9.19-60.29° | C. | 8.42-43.40° | C. | 7.87-19.51° | C. | 10.04-49.88° | C. |
| Temperature | | | | | | | | |
| Range | | | | | | | | |
| Free Leads | 21:15 | | 20:45 | | 19:00 | | 19:00 | |
| Achieved | | | | | | | | |
| Temp | | | | | | | | |
| Retort Hold | 120.21° | C. | 120.20° | C. | 120.20° | C. | 120.31° | C. |
| Temperature | | | | | | | | |

### Test Results

The data collected was computer plotted and evaluated with the CALSoft software using the Ball Formula Method. This method allows flexibility in calculating a range of process times based on different product initial temperatures and retort temperatures. The following factors were used in the Ball Formula calculation:

CALSoft Data Source File: 23031403.chp—Thermocouple #06.

Come Up time Credit: 42% of the Total Come-Up Time, 28 minutes, has been applied towards this process.

Critical Factors: The validity of the attached thermal process schedule is based upon the maintenance of certain Critical Factors assigned to this product. Factors listed as critical must be monitored, controlled, and recorded. Failure to achieve and maintain these Critical Factor conditions constitutes a process deviation.

### Commercially Sterile Process:

If the attached thermal process schedule is properly delivered to the product and the associated critical factors are properly controlled during production, this process will result in a commercial sterile product. Commercial Sterility is defined in the regulations as follows: FDA: 21 CFR 113.3(e) Commercial sterility:
(1) “Commercial sterility” of thermally processed food means the condition achieved by the application of heat which renders the food free of—
(a) Microorganisms capable of reproducing in the food under normal conditions of storage and distribution; and (b) Viable microorganisms (including spores) of public health significance.

Changes to any part of the formula or processing procedures may affect the validity of the attached scheduled process.

### Deviations:

All deviations from the attached scheduled process are handled in accordance with the following regulation: FDA: 21 CFR. 113.89 Deviations in processing, venting, or control of critical factors. Whenever any process is less than the scheduled process or when critical factors are out of control for any low-acid food or container system as disclosed from records by processor check or otherwise, the commercial processor of that low-acid food shall either fully reprocess that portion of the production involved, keeping full records of the reprocessing conditions or, alternatively, must set aside that portion of the product involved for further evaluation as to any potential public health significance. Such evaluation shall be made by a competent processing authority.

The product formulations of the present invention may contain one or more of the following ingredients: chicken parts such as breasts, thighs, wings, legs, gizzards, and the like, ground chicken, eggs, beef stew meats, ground beef, pork parts such as tenderloins, shoulder, ribs, pork belly, rump, and the like, ground pork, broths of chicken, beef, and/or pork, grains such as rice, barley, millet, spelt, buckwheat, farro, teff, corn, bulgur, oats, brown rice, sorghum, wheat, rye, amaranth, kamut, freekeh, bran, triticale, einkorn, lentils, and the like, vegetables/plants such as sweet potatoes, potatoes, broccoli, spinach, kale, beets, carrots, pumpkin, cucumber, zucchini, asparagus, celery, seaweed, and the like, beans such as kidney beans, pinto beans, chickpeas, lima beans, green beans, black-eyed peas, black beans, cannellini beans, great northern beans, fava beans, navy beans, adzuki beans, edamame, mung beans, soybeans, cranberry beans, and the like, fish parts and/or oils, such as salmon, trout, tilapia, bass, and the like, fruit extracts, such as extracts from citrus fruits, bananas, apples, nectarines, peaches, cranberries, and the like, yeast that may be enriched with elements such as sulfur, selenium, tellurium, phosphorus, nitrogen, calcium, sodium, and the like, other minerals/nutrients, and/or water.

The product formulation and preparation procedures shall not exceed the worst case conditions used during the heat penetration tests. The maximum product Fill-in Weight is 496 grams (17.50 ounces) and the retort control temperature must be at least 1° C. higher than the selected retort temperature. If the I.T. (initial temperature) is 5° C., the calculated process time and suggested process time is approximately 91-96 minutes (with the range coming from a R.T. (retort temperature) being 119, 119.5, and 120° C.), and if the I.T. is 100° C., the calculated process time is approximately 45-49 minutes (with the range coming from a R.T. (retort temperature) being 119, 119.5, and 120° C.). The Minimum Come-Up Time is 28 minutes to at least 122° C.

In an embodiment, the present invention relates to an apparatus for filling jars with malleable food comprising: a filler mechanism having a driver mechanism, the filler mechanism having inlet and outlet ports, the filler mechanism having a filler bowl such that the food can be inserted through said inlet port into said filler bowl, said driver mechanism including a portion filler for driving the food from said filler bowl through said outlet port and subsequently into a mouth opening of a jar such that the food driven through said mouth opening enters an interior region of said jar; and a cover for said jar wherein said cover is sealed to said mouth opening such that the food is contained entirely in the interior region of said jar and sealed with the cover.

In a variation, the apparatus further comprises means of creating a vacuum in the jar, creating positive pressure in the jar, heating the jar, and/or sterilizing the malleable food in the interior region of the jar. In a variation, the malleable food is a dog food. In a variation, the food from the filler bowl through the outlet port is fed intermittently to the portion filler. In a variation, the food from the filler bowl through the outlet port is fed continuously to the portion filler. In a variation, the jar is a glass jar. In a variation, the glass jar has headspace in the interior region of the jar after filling and sealing the cover to the glass jar.

In an embodiment, the present invention relates to a malleable animal food for storage in jars, said animal food comprising: at least 15% crude protein; at least 3% crude fat; a maximum of 1% crude fiber; and a maximum of 75% moisture. In a variation, the animal food comprises: at least 15% crude protein; at least 4% crude fat; a maximum of 1% crude fiber; and a maximum of 70% moisture. In a variation, the animal food comprises: at least 15% crude protein; at least 7% crude fat; a maximum of 1% crude fiber; and a maximum of 70% moisture.

In an embodiment, the present invention relates to an apparatus for filling jars comprising: a filler mechanism having a driver mechanism, the filler mechanism having inlet and outlet ports; the filler mechanism having a filler bowl such that said animal food can be inserted through said inlet port into said filler bowl, said driver mechanism including a portion filler for driving said animal food from said filler bowl through said outlet port and subsequently a mouth opening of a jar such that said animal food driven through said mouth opening enters an interior region of said jar; and a cover for said jar wherein said cover is sealed to said mouth opening such that said animal food is contained entirely by said jar and cover, said animal food sealed in said jar having a composition according to the compositions recited herein.

In an embodiment, the present invention relates to a method for filling and sealing containers for food comprising: providing ajar; providing a quantity of malleable food; providing a filler mechanism having a driver mechanism, the filler mechanism having an inlet port and an outlet port, the filler mechanism having a filler bowl; inserting the malleable food through the inlet port into the filler bowl; operating the filler mechanism such that the driver mechanism pushes the food from the filler bowl through the outlet port such that the food passes through a mouth opening of the jar and into the jar; and sealing the jar with a cover so the food is contained entirely by the jar and the cover. In a variation of the method, the method further comprises: providing a plurality of glass jars, the driver mechanism being a Point 5 single head portion filler such that the portion filler pushes the food from the filler bowl through the outlet port and into the plurality of glass jars.

In a variation, the method further comprises determining whether the Point 5 single head portion filler uniformly pumps the food such that the jars are uniformly filled. In a variation, the filler may be a portion filler. In a variation, a vacuum is created within the glass jar using a process substantially free of steam. In a variation, a positive pressure is created in the jar. In a variation, the malleable food is sterilized in the jar. Sterilization may occur prior to the food being inserted into the jar or after the food has been inserted into the jar. In a variation, a headspace is present in the jar after filling the jar with the malleable food. In a variation, the jar is heated by immersion in water. In a variation, the food is dog food.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An apparatus for filling jars with malleable food comprising:
a filler mechanism having a driver mechanism, the filler mechanism having inlet and outlet ports, the filler mechanism having a filler bowl such that the food can be inserted through said inlet port into said filler bowl, said driver mechanism including a portion filler for driving the food from said filler bowl through said outlet port and subsequently into a mouth opening of a jar such that the food driven through said mouth opening enters an interior region of said jar; and
a cover for said jar wherein said cover is sealed to said mouth opening such that the food is contained entirely in the interior region of said jar and sealed with the cover.

2. The apparatus of claim 1, wherein the apparatus further comprises means of creating a vacuum in the jar, creating positive pressure in the jar, heating the jar, and/or sterilizing the malleable food in the interior region of the jar.

3. The apparatus of claim 1, wherein the malleable food is a dog food.

4. The apparatus of claim 1, wherein the food from the filler bowl through the outlet port is fed intermittently to the portion filler.

5. The apparatus of claim 1, wherein the food from the filler bowl through the outlet port is fed continuously to the portion filler.

6. The apparatus of claim 1, wherein the jar is a glass jar.

7. The apparatus of claim 6, wherein the glass jar has headspace in the interior region of the jar after filling and sealing the cover to the glass jar.

8. A malleable animal food for storage in jars, said animal food comprising:
at least 15% crude protein;
at least 3% crude fat;
a maximum of 1% crude fiber; and
a maximum of 75% moisture.

9. The malleable animal food of claim 8, said animal food comprising:
at least 15% crude protein;
at least 4% crude fat;
a maximum of 1% crude fiber; and
a maximum of 70% moisture.

10. The malleable animal food of claim 9, said animal food comprising:
at least 15% crude protein;
at least 7% crude fat;
a maximum of 1% crude fiber; and
a maximum of 70% moisture.

11. An apparatus for filling jars comprising:
a filler mechanism having a driver mechanism, the filler mechanism having inlet and outlet ports;
the filler mechanism having a filler bowl such that said animal food can be inserted through said inlet port into said filler bowl, said driver mechanism including a portion filler for driving said animal food from said filler bowl through said outlet port and subsequently a mouth opening of a jar such that said animal food driven through said mouth opening enters an interior region of said jar; and
a cover for said jar wherein said cover is sealed to said mouth opening such that said animal food is contained entirely by said jar and cover, said animal food sealed in said jar having a composition according to claims 8-10.

12. A method for filling and sealing containers for food comprising:
providing ajar;
providing a quantity of malleable food;
providing a filler mechanism having a driver mechanism, the filler mechanism having an inlet port and an outlet port, the filler mechanism having a filler bowl;
inserting the malleable food through the inlet port into the filler bowl;
operating the filler mechanism such that the driver mechanism pushes the food from the filler bowl through the outlet port such that the food passes through a mouth opening of the jar and into the jar; and
sealing the jar with a cover so the food is contained entirely by the jar and the cover.

13. The method according to claim 12 further comprising:
providing a plurality of glass jars, the driver mechanism being a Point 5 single head portion filler such that the portion filler pushes the food from the filler bowl through the outlet port and into the plurality of glass jars.

14. The method of claim 13, further comprising;
determining whether the Point 5 single head portion filler uniformly pumps the food such that the jars are uniformly filled.

15. The method of claim 12, wherein;
a vacuum is created within the glass jar using a process substantially free of steam.

16. The method of claim 12:
wherein a positive pressure is created in the jar.

17. The method of claim 12, wherein the malleable food is sterilized in the jar.

18. The method of claim 12, wherein a headspace is present in the jar after filling the jar with the malleable food.

19. The method of claim 12, wherein the jar is heated by immersion in water.

20. The method of claim 12, wherein the food is dog food.
